(19) United States
(12) Patent Application Publication
(10) Pub. No.: US 2005/0187118 A1
(43) Pub. Date: Aug. 25, 2005

(54) Cleaning solution, method for cleaning semiconductor substrate using the same, and method for forming metal wiring

(76) Inventors: Takayuki Haraguchi, Kawasaki-shi (JP); Shigeru Yokoi, Kawasaki-shi (JP); Kazumasa Wakiya, Kawasaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/034,864

(22) Filed: Jan. 14, 2005

(30) Foreign Application Priority Data
Jan. 23, 2004 (JP) 2004-16139

(51) Int. Cl. C23G 1/00; C11D 1/00

(52) U.S. Cl. 510/175; 134/2

(57) ABSTRACT

The stripping-cleaning solution can advantageously strip a deposit generated on the top surface of a wiring without excessively etching the metal layer which constitutes the sidewall of the metal wiring pattern and the top surface of the wiring. The stripping-cleaning solution comprises at least a fluorine compound, a water-soluble organic solvent, water, and a bidentate ligand in an amount of 0.1 to 20% by mass based on the total mass of the tripping-cleaning solution. Alternatively, the stripping-cleaning solution comprises at least a basic aqueous solution, at least one selected from an organic compound having a carboxyl group and an anhydride thereof, water, and a bidentate ligand in an amount of 0.5 to 10% by mass based on the total mass of the stripping-cleaning solution.

### CROSS-REFERENCE TO RELATED APPLICATIONS

This application claims the benefit of the priority of Japanese Patent Application No. 2004-16139, filed on Jan. 23rd, 2004, and the disclosure of which is incorporated by reference herein in its entirety.

### BACKGROUND OF THE INVENTION

1) Field of the Invention

The present invention relates to a stripping-cleaning solution, and more particularly, the present invention relates to a stripping-cleaning solution which can advantageously strip a deposit on the top surface and the sidewall of a wiring without excessively etching the metal layer which constitutes the sidewall of the wiring pattern and the top surface of the wiring. In addition, the present invention also relates to a method for cleaning a semiconductor substrate and a method for forming a metal wiring, using the stripping-cleaning solution.

2) Description of the Related Art

Metal wiring of integrated circuits (ICs), large scale integrations (LSIs) and the like is formed as follows. Namely, a photoresist is uniformly applied to a metal wiring layer comprised of aluminum (Al), titanium nitride (TiN), copper (Cu) or an aluminum alloy and the like, or to an insulating film, such as a SiO₂ film, formed on a substrate. The photoresist is subjected to exposure and development treatment to form a resist pattern, and the metal wiring layer or insulating film is subjected to selective etching using the resist pattern as a mask to form a microcircuit. The unnecessary resist layer is then removed by O₂ plasma ashing or using a stripping solution, thus producing a metal wiring.

With respect to the stripping treatment for removing the unnecessary resist layer, a variety of stripping solutions (for example, Patent Documents 1 (Japanese Patent Application Laid-open No. 2001-330970), 2 (Japanese Patent No. 3283612), 3 (Japanese Patent Application Laid-open No. 2001-1835850), 4 (Japanese Patent Application Laid-open No. 2002-278092), and 5 (Japanese Patent Application Laid-open No. 2003-129089) and the like) and stripping methods (for example, Patent Document 6 (Japanese Patent Application Laid-open No. 2002-202619) and the like) have been proposed.

On the other hand, it has been known that substance is deposited by selective etching and the like wherein the deposited substance cannot be removed by the above mentioned stripping solution or stripping method. It is explained below with reference to FIGS. 1A to 1C.

FIGS. 1A to 1C are views for explaining the process for forming the metal wiring. As shown in FIG. 1A, a resist mask 5 is first formed on a metal wiring layer using titanium nitride (TiN) or aluminum (Al). Selective etching is then conducted according to the mask to form a metal wiring (FIG. 1B). The unnecessary resist mask 5 is then removed by O₂ plasma ashing (FIG. 1C).

It is known that a deposit 6 is accumulated on the sidewall of the metal wiring as a fence-like form at the step shown in FIG. 1B. The deposit on the sidewall has been removed using a stripping solution for resist, especially effective in removing the deposit on the sidewall, and, for example, the present inventors have removed it using a stripping composition for resist, including hydrofluoric acid, a water-soluble organic solvent, and a corrosion inhibitor (for example, Patent Document 7 (Japanese Patent No. 3236220) and 8 (Japanese Patent No. 3255551)). With respect to the etching product deposited on the sidewall of an electrode including any one of platinum, iridium and iridium oxide, removal using a chemical solution including acetoacetylacetone or hexafluoroacetylacetone has been proposed (for example, Patent Document 9 (Japanese Patent Application Laid-open No. 2001-351898) and the like).

However, as shown in FIG. 1C, in addition to the deposit 6 on the sidewall, another deposit 7 is locally generated on the top surface of the wiring. This deposit cannot be removed by the stripping composition for resist disclosed in the Patent Documents 7 and 8. Therefore, various studies have been made on the method for removing the deposit. However, for example, when the stripping solution is increased in strength, the metal layer constituting the sidewall or the top surface of the wiring is excessively etched, and hence such a strong stripping solution cannot be practically used. Furthermore, in the method in which the deposit is removed by a physical method, such as etching or ashing, it is difficult to effectively remove only the deposit without causing damage in the portion around the deposit because the deposit is deposited locally.

This deposit is deposited locally as mentioned above, and may provide electrically adverse affect in the process for forming a multilayer structure, and therefore there has been desired a stripping solution which selectively strips a deposit on a wiring without excessively etching the metal layer constituting the sidewall or the top surface of the wiring.

In each of the above patent documents, the problem of a deposit on the wiring is not mentioned, and hence it is not described as the problem to be solved.

### SUMMARY OF THE INVENTION

For solving the above problems, the present inventors have first made studies on the properties and constituents of a deposit on a wiring. As a result, it is considered that the deposit on the top surface of the wiring is derived from the deposit on the sidewall. However, it is presumed that the deposit on the top surface of the wiring is further hardened due to the effect of ashing and the like as compared to the deposit on the sidewall. Furthermore, from the presumption that the deposit on the top surface of the wiring is derived from the deposit on the sidewall, it is considered that the constituents of the deposit are an organic material containing a metal component, such as Al or TiN.

From these presumptions, the present inventors have made extensive studies on the components of the stripping-cleaning solution. As a result, it has been found that, when a bidentate ligand is contained in an appropriate amount as a component of the stripping-cleaning solution, it is possible to form a complex from a metal component in the deposit, thereby enabling to advantageously remove the deposit, at the same time, the metal layer constituting the sidewall or the top surface of the wiring is not excessively etched. In other words, the object of the present invention is to strip a deposit on the top surface of the wiring selectively. In order to specialize to the object, the bidentate ligand is contained in the stripping-cleaning solution, thereby completing the present invention.

The present invention has been achieved based on the above findings, and the stripping-cleaning solution according to the present invention is capable of stripping and removing a deposit generated at least on the top surface of a metal wiring of a semiconductor substrate, wherein the stripping-cleaning solution comprises at least a fluorine compound, a water-soluble organic solvent, water, and a bidentate ligand in an amount of 0.1 to 20% by mass based on the total mass of the stripping-cleaning solution.

Furthermore, the stripping-cleaning solution according to the present invention is capable of stripping and removing a deposit generated at least on the top surface of a metal wiring of a semiconductor substrate, wherein the stripping-cleaning solution comprises at least a basic aqueous solution, at least one selected from a carboxylic acid compound and an anhydride thereof, water, and a bidentate ligand in an amount of 0.5 to 10% by mass based on the total mass of the stripping-cleaning solution.

Further, the method for cleaning a semiconductor substrate according to the present invention comprises a step of bringing the stripping-cleaning solution into contact with a semiconductor substrate in a process for forming a metal wiring to remove a deposit generated at least on the top surface of the metal wiring.

Further, the method for forming a metal wiring according to the present invention comprises steps of:
forming a metal wiring layer on a substrate;
forming a photoresist layer on the metal wiring layer obtained at the step of forming a metal wiring layer, and subjecting the photoresist layer to exposure and development treatment to form a predetermined photoresist pattern;
subjecting the metal wiring layer to dry etching using the photoresist pattern as a mask obtained at the step of forming a photoresist pattern to form a predetermined metal wiring pattern;
removing the unnecessary resist layer by O₂ plasma ashing after forming the metal wiring pattern; and
removing a deposit generated at least on the top surface of the metal wiring after the step of removing the resist by using the above mentioned stripping-cleaning solution.

In the Patent Documents 3 and 4, a chelating agent is used as a metal corrosion inhibitor, and therefore the purpose of incorporation of the chelating agent and hence the amount of it is different from those in the present invention. Furthermore, in the Patent Document 5, a chelating agent is used as a metal corrosion inhibitor, and acetylacetone is described as merely an example of an organic solvent, and therefore the purpose of incorporation of the chelating agent and acetylacetone and hence the amounts of them are different from those in the present invention.

In the present invention, there can be provided a stripping-cleaning solution which can advantageously strip a deposit on the top surface of a wiring without excessively etching the metal layer which constitutes the sidewall of the metal wiring pattern and the top surface of the wiring. In addition, there can be provided a method for cleaning a semiconductor substrate and a method for forming a metal wiring, using the above mentioned stripping-cleaning solution.

What is described above and other objects, characteristics, and advantages of the present invention will be explained below in the detailed descriptions, with reference to the accompanying drawings.

### BRIEF DESCRIPTION OF THE DRAWING

FIGS. 1A to 1C are views for explaining the process for forming a metal wiring.

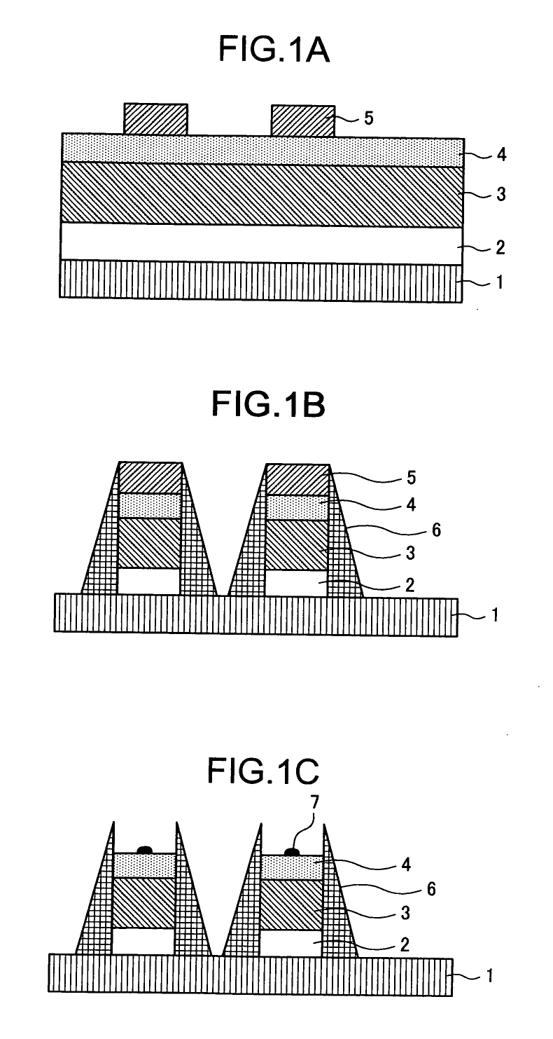

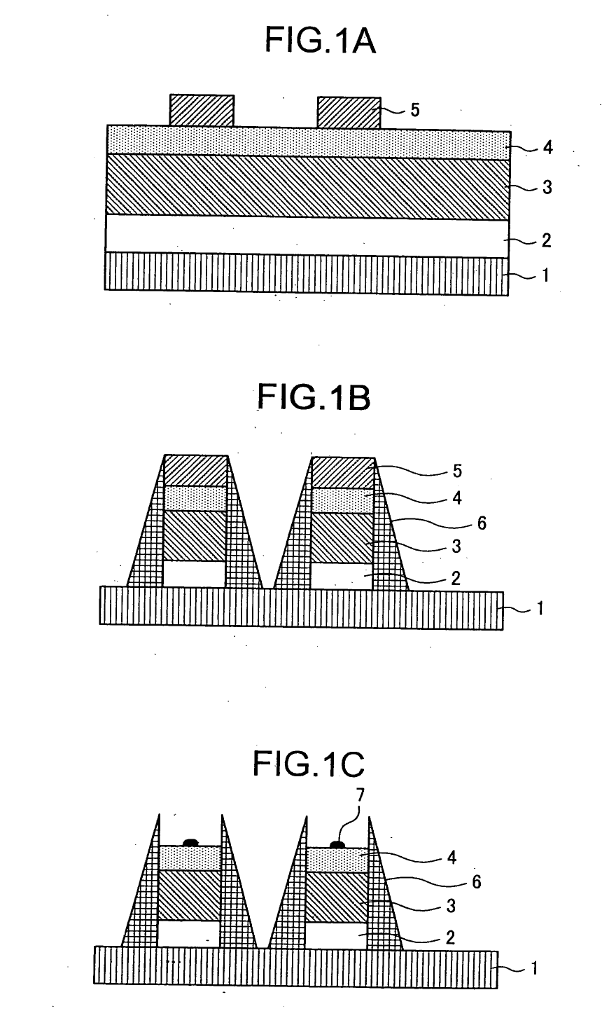

In the drawings, each reference numerals represent as follows:

1 Semiconductor substrate
2 TiN layer
3 Al layer
4 TiN layer
5 Resist mask
6 Deposit on sidewall of metal wiring
7 Deposit on top surface of wiring

### DETAILED DESCRIPTIONS

Exemplary embodiments of the present invention will be explained below.

[I] Stripping-cleaning solution (A) according to the present invention comprises at least a fluorine compound, a water-soluble organic solvent, water, and a bidentate ligand in an amount of 0.1 to 20% by mass based on the total mass of the stripping-cleaning solution.

(a-1) Fluorine Compound

As the fluorine compound used in the present invention, any fluorine compound can be used as long as it does not adversely affect the other components of the stripping-cleaning solution, and specific examples include hydrofluoric acid, ammonium fluoride (NH₄F), and tetramethylammonium fluoride (TMAF). These compounds can be used individually or in combination. The amount of the fluorine compound incorporated can be 0.1 to 20% by mass, preferably 0.1 to 10% by mass, further preferably 0.1 to 1.0% by mass, based on the total mass of the stripping-cleaning solution. When the amount falls outside of the range, for example, when the amount is smaller than the lower limit, the collective stripping ability is likely to be poor. Whereas, when the amount exceeds the upper limit, it is likely that corrosion is caused in the constituent layer of the substrate.

(a-2) Water-Soluble Organic Solvent

As the water-soluble organic solvent used in the present invention, a generally used water-soluble organic solvent can be used. The water-soluble organic solvent is roughly classified into an alkanolamine water-soluble organic solvent and the other water-soluble organic solvent, and a water-soluble organic solvent can be appropriately selected.

Specific examples of the alkanolamine water-soluble organic solvents include monoethanolamine (MEA), diethanolamine, triethanolamine, 2-(2-aminoethoxy)ethanol, N,N-dimethylethanolamine, N,N-diethylethanolamine, N,N-dibutylethanolamine, N-methylethanolamine, N-ethylethanolamine, N-butylethanolamine, N-methyldiethanolamine, monoisopropanolamine, diisopropanolamine, and triisopropanolamine.

Among these, preferably selected are monoethanolamine, 2-(2-aminoethoxy)ethanol, and N-methylethanolamine. Either one type of alkanolamine water-soluble organic solvent or a mixture of two types or more of alkanolamine water-soluble organic solvents can be used.

Specific examples of water-soluble organic solvents other than the alkanolamine water-soluble organic solvents include sulfoxides, such as dimethyl sulfoxide; sulfones, such as dimethyl sulfone, diethyl sulfone, bis(2-hydroxyethyl)sulfone, and tetramethylene sulfone; amides, such as N,N-dimethylformamide, N-methylformamide, N,N-dimethylacetamide, N-methylacetamide, and N,N-diethylacetamide; lactams, such as N-methyl-2-pyrrolidone, N-ethyl-2-pyrrolidone, N-hydroxymethyl-2-pyrrolidone, and N-hydroxyethyl-2-pyrrolidone; lactones, such as α-propiolactone, γ-butyrolactone, γ-valerolactone, 6-valerolactone, γ-caprolactone, and ε-caprolactone; imidazolidinones, such as 1,3-dimethyl-2-imidazolidinone, 1,3-diethyl-2-imidazolidinone, and 1,3-diisopropyl-2-imidazolidinone; polyhydric alcohols, such as ethylene glycol, ethylene glycol monomethyl ether, ethylene glycol monoethyl ether, ethylene glycol monobutyl ether, ethylene glycol monoacetate, ethylene glycol monomethyl ether acetate, ethylene glycol monoethyl ether acetate, diethylene glycol, diethylene glycol monoacetate, diethylene glycol monomethyl ether, diethylene glycol monoethyl ether, diethylene glycol monobutyl ether, propylene glycol, propylene glycol monomethyl ether, dipropylene glycol monomethyl ether, glycerol, 1,2-butylene glycol, 1,3-butylene glycol, and 2,3-butylene glycol; and derivatives thereof. These solvents can be used individually or in combination.

Among these, preferred is at least one solvent selected from dimethyl sulfoxide, dimethylimidazolidinone, N-methyl-2-pyrrolidone (NMP), and diethylene glycol monobutyl ether.

The water-soluble organic solvent is preferably incorporated in an amount of 40 to 80% by mass, especially preferably 50 to 70% by mass, based on the total mass of the stripping-cleaning solution. When the amount falls outside of the range, for example, when the amount is smaller than the lower limit, the collective stripping ability is likely to be poor. Whereas, when the amount exceeds the upper limit, it is likely that corrosion is caused in the constituent layer of the substrate.

The water-soluble organic solvent can be either an alkanolamine water-soluble organic solvent or the other water-soluble organic solvent, but, when either one is used individually, it is preferred that a water-soluble organic solvent other than the alkanolamine water-soluble organic solvent is used. In this case, corrosion of, e.g., Low-k material can be further suppressed, as compared to the case where the alkanolamine water-soluble organic solvent is solely used.

Both the alkanolamine water-soluble organic solvent and the other water-soluble organic solvent can be used in the form of a mixed solvent. The use of such a mixed solvent can improve the stripping performance for residue of the resist film and metal.

When the mixed solvent is used, the alkanolamine water-soluble organic solvent is preferably incorporated in an amount of 40 to 80% by mass, especially preferably 50 to 70% by mass, based on the total mass of the stripping-cleaning solution. The water-soluble organic solvent other than the alkanolamine water-soluble organic solvent constitutes the remainder of the total amount of the water-soluble organic solvents, excluding the alkanolamine water-soluble organic solvent.

(a-3) Water

Water used in stripping-cleaning solution (A) according to the present invention constitutes the remainder of the stripping-cleaning solution, excluding the other components, but it is preferably incorporated in an amount of 10 to 50% by mass, especially preferably 20 to 40% by mass, based on the total mass of stripping-cleaning solution (A). When the amount falls outside of the range, for example, when the amount is smaller than the lower limit, the removing ability for the residue is likely to be poor. Whereas, when the amount exceeds the upper limit, a metal remaining in the substrate, such as Al or Cu, is likely to suffer corrosion.

(a-4) Bidentate Ligand

The bidentate ligand used in the present invention can be any compound as long as it is a metal chelate that can occupy two coordination sites, namely, has two atoms which are capable of simultaneously coordinating to a metal. Examples of such bidentate ligands include inorganic acids, such as SO₄, CO₃, SO₃, and PO₄; dicarboxylic acids, such as C₂O₄ and C₆H₄(COO)₂; oxycarboxylic acids, such as salicylato and glycolato; dioxy compounds, such as catecholato; oxyoximes; oxycarboxylic acids; oxyaldehydes and derivatives thereof, such as salicylaldehydato and oxyacetophenato; dioxy compounds, such as biphenolato; diketones and analogues thereof, such as acetylacetonato, dibenzoylmethanato, diethylmalonato, and ethylacetoacenato; oxyquinones, such as pyromeconato, oxynaphthoquinonato, and oxyanthraquinonato; tropolones, such as tropolonato and hinokitiolato; N-oxide compounds; aminocarboxylic acids and analogues thereof, such as glycinato, alaninato, anthraninato, and picolinato; hydroxyamines, such as aminophenolato, ethanolaminato, and mercaptoethylaminato; oxines, such as 8-oxyquinolinato; aldimines, such as salicylaldiminato; oxyoximes, such as benzoin oximato and salicylaldoximato; oxyazo compounds, such as oxyazobenzenato and phenylazonaphtholato; nitrosonaphthols, such as β-nitroso-α-naphtholato; triazenes, such as diazoaminobenzenato; biurets, such as biuretato and polypeptide groups; formazanes and dithizones, such as diphenylcarbanato and diphenylthiocarbanato; biguanides, such as biguanidato; glyoximes, such as dimethylglyoximato; dioxy compounds, such as glycol and glycerol; diketone compounds; oxyoximes, such as benzoin oxime; diamines and analogues thereof, such as ethylenediamine, phenylenediamine, dipyridyl, and phenanthroline; hydrazine derivatives, such as pyridylhydrazine; glyoximes, such as dimethylglyoxime; and thioethers, such as dithioether. These ligands can be used individually or in combination.

The amount of the bidentate ligand incorporated is 0.1 to 20% by mass, preferably 0.1 to 10% by mass, based on the total mass of the stripping-cleaning solution. When the amount falls outside of the range, for example, when the amount is smaller than the lower limit, the removing ability for the residue is likely to be poor. Whereas, when the amount exceeds the upper limit, it is likely that corrosion is caused in the wiring layer.

In the bidentate ligand used in the present invention, for example, O, N, or S atoms simultaneously coordinate to a metal to form a 5-membered ring, 6-membered ring, or 7-membered ring, forming a chelate compound. Among these, preferred are oxygen atoms.

Furthermore, it is preferred that the bidentate ligand is a compound represented by the general formula (1) below since it has high chelate formability. 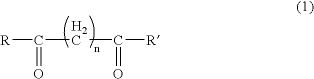
wherein n represents an integer of 0 to 3, and each of R and R′ represents an alkyl group, an aryl group, or a derivative thereof.

Examples of compounds represented by general formula (1) include α-diketone, such as diacetyl and acetylbenzoyl; β-diketone, such as acetylacetone, benzoylacetone, and dibenzoylacetone; γ-diketone, such as acetonylacetone and phenacylacetone; and δ-diketone, such as 2,6-heptanedione. Among these, preferred are β-diketone compounds, such as acetylacetone, benzoylacetone, and dibenzoylacetone since they form a remarkably stable complex (chelate).

The bidentate ligand and a metal component of the deposit on the top surface of the metal layer, such as Al or TiN, form together a complex, so that not only the deposit on the sidewall but also the deposit on the top surface of the wiring are advantageously dissolved. On the other hand, the metal layer constituting the sidewall or the top surface of the wiring is not excessively etched.

[II] Stripping-cleaning solution (B) according to the present invention comprises at least a basic aqueous solution, at least one selected from an organic compound having a carboxyl group and an anhydride thereof, water, and a bidentate ligand in an amount of 0.5 to 10% by mass based on the total mass of the stripping-cleaning solution.

(b-1) Basic Aqueous Solution

With respect to the basic aqueous solution used in the present invention, there is no particular limitation as long as it is an aqueous solution which is basic, but preferred is aqueous ammonia from the viewpoint of easy handling and availability. Aqueous ammonia which is generally commercially available can be used. Alternatively, a quaternary ammonium hydroxide can be used. Examples of quaternary ammonium hydroxides include tetramethylammonium hydroxide, tetraethylammonium hydroxide, tetrapropylammonium hydroxide, tetrabutylammonium hydroxide, methyltripropylammonium hydroxide, methyltributylammonium hydroxide, and 2-hydroxyethyltrimethylammonium hydroxide. The amount of the basic aqueous solution (when aqueous ammonia is used, for example, 10% aqueous ammonia) incorporated can be 1 to 50% by mass, preferably 5 to 15% by mass, based on the total mass of stripping-cleaning solution (B). When the amount falls outside of the range, for example, when the amount is smaller than the lower limit, the collective stripping ability is likely to be poor. Whereas, when the amount exceeds the upper limit, it is likely that corrosion is caused in the constituent layer of the substrate.

(b-2) Organic Compound Having a Carboxyl Group and Anhydride Thereof

Examples of organic compounds having a carboxyl group and anhydrides thereof include formic acid, acetic acid, propionic acid, butyric acid, isobutyric acid, oxalic acid, malonic acid, succinic acid, glutaric acid, maleic acid, fumaric acid, benzoic acid, phthalic acid, 1,2,3-benzenetricarboxylic acid, glycolic acid, lactic acid, malic acid, citric acid, acetic anhydride, phthalic anhydride, maleic anhydride, succinic anhydride, and salicylic acid. Preferred examples of the organic compounds having a carboxyl group include acetic acid, formic acid, phthalic acid, benzoic acid, phthalic anhydride, and salicylic acid, and especially preferred are acetic acid, phthalic acid, phthalic anhydride, and salicylic acid. These compounds can be used individually or in combination. The amount of the organic compound having a carboxyl group or anhydride thereof incorporated can be 1 to 50% by mass, preferably 5 to 15% by mass, based on the total mass of stripping-cleaning solution (B). When the amount falls outside of the range, for example, when the amount is smaller than the lower limit, the collective stripping ability is likely to be poor. Whereas, when the amount exceeds the upper limit, it is likely that corrosion is caused in the constituent layer of the substrate.

(b-3) Water

Water used in stripping-cleaning solution (B) according to the present invention constitutes the remainder of the stripping-cleaning solution, excluding the other components, but it is preferably incorporated in an amount of 50 to 90% by mass, especially preferably 50 to 80% by mass, based on the total mass of stripping-cleaning solution (B). When the amount falls outside of the range, for example, when the amount is smaller than the lower limit, the removing ability for the residue is likely to be poor. Whereas, when the amount exceeds the upper limit, a metal remaining in the substrate, such as Al, TiN, or Cu, is likely to suffer corrosion.

As the bidentate ligand, the same bidentate ligand as that described in item (a-4) above can be used. The amount of the bidentate ligand incorporated is 0.5 to 10% by mass, preferably 1.0 to 10% by mass, further preferably 1.0 to 8.0% by mass, based on the total mass of the stripping-cleaning solution. When the amount is smaller than the lower limit, the removing ability for the residue is likely to be poor, and, when the amount exceeds the upper limit, the bidentate ligand is not dissolved in the solution containing the other components (causing phase separation or causing oil to appear on the surface of the solution).

Each of stripping-cleaning solutions (A) and (B) can further comprise at least one selected from a corrosion inhibitor and a surfactant.

As the corrosion inhibitor used in the present invention, at least one selected from a benzotriazole compound, a mercapto group-containing compound, and a saccharide can be used. Examples of the benzotriazole compounds include benzotriazole compounds represented by the following general formula (2):

preferably used. The amount of the surfactant added is preferably in the range of less than 0.5% by mass.

The most preferred mode of stripping-cleaning solution (A) according to the present invention comprises 0.6% by mass of ammonium fluoride, 0.4% by mass of tetramethylammonium fluoride, N-methyl-2-pyrrolidone (NMP) constituting the remainder of the stripping-cleaning solution, 30% by mass of water, 1% by mass of acetylacetone, 0.1% by mass of acetylenol as a surfactant, and 0.5% by mass of thioglycerol as a corrosion inhibitor.

The most preferred mode of stripping-cleaning solution (B) according to the present invention comprises an aqueous solution of ammonium acetate obtained by mixing together 10% aqueous ammonia and a 10% aqueous solution of acetic acid to adjust pH to 5.0, and acetylacetone in an amount of 1% by mass, based on the total mass of the aqueous solution of ammonium acetate.

The method for cleaning a semiconductor substrate according to the present invention comprises a step of bringing the stripping-cleaning solution into contact with a semiconductor substrate in a process for forming a metal wiring to remove a deposit at least on the top surface of the metal wiring.

With respect to the method in which the stripping-cleaning solution is brought into contact with a semiconductor substrate to clean and remove a deposit, there is no particular limitation as long as it is a cleaning and removing method generally used. Specific examples include a dipping method, a paddle method, and a shower method. In the dipping method, a deposit can be cleaned and removed in a time as short as 1 to 5 minutes at 25° C. when using stripping-cleaning solution (A) or at 70° C. when using stripping-cleaning 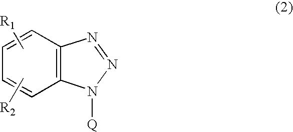
wherein each of R₁ and R₂ independently represents a hydrogen atom, a substituted or unsubstituted hydrocarbon group having 1 to 10 carbon atoms, a carboxyl group, an amino group, a hydroxyl group, a cyano group, a formyl group, a sulfonylalkyl group, or a sulfo group, and Q represents a hydrogen atom, a hydroxyl group, a substituted or unsubstituted hydrocarbon group having 1 to 10 carbon atoms (which optionally has in its structure an amide linkage or an ester linkage), an aryl group, or a group represented by the following general formula (3): 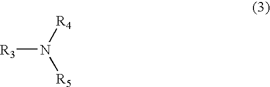
wherein R₃ represents an alkyl group having 1 to 6 carbon atoms, and each of R₄ and R₅ independently represents a hydrogen atom, a hydroxyl group, or a hydroxyalkyl group or alkoxyalkyl group having 1 to 6 carbon atoms.

In the present invention, in the definition of each of Q, R₁, and R₂ in general formula (2), the hydrocarbon group can be either an aromatic hydrocarbon group or an aliphatic hydrocarbon group, can have a saturated or unsaturated bond, and can be comprised of either a linear chain or a branched chain. Examples of substituted hydrocarbon groups include a hydroxyalkyl group and an alkoxyalkyl group.

In general formula (2), it is especially preferred that Q is a group represented by general formula (3). Especially, it is preferred to select the group of general formula (3) wherein each of R₄ and R₅ independently represents a hydroxyalkyl group or alkoxyalkyl group having 1 to 6 carbon atoms.

Furthermore, a group of Q is preferably used such that the compound of general formula (2) is water soluble. Specifically, it is preferred that Q is a hydrogen atom, an alkyl group having 1 to 3 carbon atoms (specifically, a methyl group, an ethyl group, a propyl group, or an isopropyl group), a hydroxyalkyl group having 1 to 3 carbon atoms, or a hydroxyl group.

Specific examples of benzotriazole compounds include benzotriazole, 5,6-dimethylbenzotriazole, 1-hydroxybenzotriazole, 1-methylbenzotriazole, 1-aminobenzotriazole, 1-phenylbenzotriazole, 1-hydroxymethylbenzotriazole, methyl 1-benzotriazolecarboxylate, 5-benzotriazolecarboxylic acid, 1-methoxy-benzotriazole, 1-(2,2-dihydroxyethyl)-benzotriazole, 1-(2,3-dihydroxypropyl)benzotriazole, and “IRGAMET (trade name)” series commercially available from Ciba Specialty Chemicals K.K., i.e., 2,2′-{[(4-methyl-1H-benzotriazol-1-yl)methyl]-imino}bisethanol, 2,2′-{[(5-methyl-1H-benzotriazol-1-yl)methyl]-imino}bisethanol, 2,2′-{[(4-methyl-1H-benzotriazol-1-yl)methyl]-imino}bisethane, and 2,2′-{[(4-methyl-1H-benzotriazol-1-yl)methyl]-imino}bispropane. Among these, 1-(2,3-dihydroxypropyl)-benzotriazole, 2,2′-{[(4-methyl-1H-benzotriazol-1-yl)methyl]-imino}bisethanol, or 2,2′-{[(5-methyl-1H-benzotriazol-1-yl)methyl]-imino}bisethanol is preferably used.

As the mercapto group-containing compound, preferred is a compound of a structure having any one of a hydroxyl group and a carboxyl group or both at least one of the α-position and the β-position relative to the carbon atom bonded to the mercapto group. Specific preferred examples of such compounds include 1-thioglycerol, 3-(2-aminophenylthio)-2-hydroxypropylmercaptan, 3-(2-hydroxyethylthio)-2-hydroxypropylmercaptan, 2-mercaptopropionic acid, and 3-mercaptopropionic acid. Among these, 1-thioglycerol is especially preferably used.

As the saccharide, so-called saccharide generally represented by Cₙ(H₂O)ₘ (wherein each of n and m is an integer equal to or more than 0) or sugar alcohol obtained by reducing a carbonyl group in the saccharide is used, and specific examples include D-sorbitol, arabitol, mannitol, xylitol, cane sugar, and starch, and, among these, preferred are xylitol and D-sorbitol.

The corrosion inhibitor is preferably incorporated in an amount of 0.1 to 10% by mass, especially preferably 0.2 to 8% by mass, based on the total mass of the stripping-cleaning solution. When the amount falls outside of the range, for example, when the amount is smaller than the lower limit, Al or Cu is likely to suffer corrosion. Whereas, when the amount exceeds the upper limit, an effect expected by increasing the amount cannot be obtained.

As the surfactant used in the present invention, for example, an acetylenic alcohol surfactant generally used in a stripping-cleaning solution is solution (B).

By the method for cleaning a semiconductor substrate according to the present invention, the sidewall and top surface of a metal wiring becomes smooth, and therefore a semiconductor substrate having high reliability can be provided.

The method for forming a metal wiring according to the present invention comprises steps of: forming a metal wiring layer on a substrate; forming a photoresist layer on the metal wiring layer obtained at the step of forming a metal wiring layer, and subjecting the photoresist layer to exposure and development treatment to form a predetermined photoresist pattern; subjecting the metal wiring layer to dry etching using the photoresist pattern as a mask obtained at the step of forming a photoresist pattern to form a predetermined metal wiring pattern; removing the unnecessary resist layer by O₂ plasma ashing after forming the metal wiring pattern; and removing a deposit generated at least on the top surface of the metal wiring after the step of removing the resist by using the above mentioned stripping-cleaning solution.

### EXAMPLES

The present invention will be explained in further detail below with reference to the Examples. Note that the present invention will not be limited thereto.

Stripping-Cleaning Solution (A)

### Examples 1 and 2

A substrate having an Al wiring layer formed was subjected to dry etching in accordance with a method generally used to form a wiring pattern. The unnecessary resist film was then removed by O₂ plasma ashing, and the resultant Al wiring substrate was cleaned by a dipping method at 25° C. for 3 minutes using a stripping-cleaning solution shown in Table 1. After the cleaning, the substrate was washed with running pure water, and dried under N₂ blow, and then baked at 100° C. for 10 minutes, and the resultant substrate was examined under a scanning electron microscope (SEM).

As can be seen from Table 2, when acetylacetone which is a β-diketone compound was incorporated as a bidentate ligand, both the deposit on the sidewall of the wiring and the deposit on the top surface of the wiring could be removed.

In Table 2, with respect to the removal of the deposited substance, the symbols represent as follows: “O: Completely removed”; and “X: Could not removed”.

### Comparative Example 1

Using a stripping-cleaning solution having substantially the same composition as that in Examples 1 and 2 except that acetylacetone (β-diketone compound) as a bidentate ligand was not incorporated as shown in Table 1, the wiring substrate was cleaned by a dipping method at 25° C. for 3 minutes. After the cleaning, the substrate was washed with running pure water, and dried under N₂ blow, and then baked at 100° C. for 10 minutes, and the resultant substrate was examined under a scanning electron microscope (SEM).

As can be seen from Table 2, the deposit on the sidewall of the wiring could be removed, but the deposit on the top surface of the wiring could not be removed.

TABLE 1

| | DMSO | H₂O | NH₄F | | |
|---|---|---|---|---|---|
| | (% by | (% by | (% by | Acetylenol | Acetylacetone |
| | mass) | mass) | mass) | (% by mass) | (% by mass) |
| Example 1 | 68.8 | 30 | 1.0 | 0.1 | 0.1% |
| Example 2 | 68.6 | 30 | 1.0 | 0.1 | 0.3% |
| Comparative | 68.9 | 30 | 1.0 | 0.1 | — |
| Example 1 | | | | | |

TABLE 2

| | Deposit on | Deposit on top |
|---|---|---|
| | sidewall of wiring | surface of wiring |
| Example 1 | ◯ | ◯ |
| Example 2 | ◯ | ◯ |
| Comparative | ◯ | X |
| Example 1 | | |

### Examples 3 and 4

A substrate having an Al wiring layer formed was subjected to dry etching in accordance with a method generally used to form a wiring pattern. The unnecessary resist film was then removed by O₂ plasma ashing, and the resultant Al wiring substrate was cleaned by a dipping method at 25° C. for 3 minutes using a stripping-cleaning solution shown in Table 3. After the cleaning, the substrate was washed with running pure water, and dried under N₂ blow, and then baked at 100° C. for 10 minutes, and the resultant substrate was examined under a scanning electron microscope (SEM).

As can be seen from Table 4, when acetylacetone (β-diketone compound) was incorporated as a bidentate ligand, both the deposit on the sidewall of the wiring and the deposit on the top surface of the wiring could be completely removed.

In Table 4, with respect to the removal of the deposited substance, the symbols represent as follows: “O: Completely removed”; and “Δ: Partially remained”.

### Comparative Example 2

Using a stripping-cleaning solution having substantially the same composition as that in Examples 3 and 4 except that acetylacetone (β-diketone compound) as a bidentate ligand was not incorporated as shown in Table 3, the wiring substrate was cleaned by a dipping method at 25° C. for 3 minutes. After the cleaning, the substrate was washed with running pure water, and dried under N₂ blow, and then baked at 100° C. for 10 minutes, and the resultant substrate was examined under a scanning electron microscope (SEM).

As can be seen from Table 4, the deposit on the sidewall of the wiring could be completely removed, but the deposit on the top surface of the wiring was partially remained.

TABLE 3

| | NMP | H₂O | NH₄F | TMAF | Thioglycerol | Acetylenol | |
|---|---|---|---|---|---|---|---|
| | (% by | (% by | (% by | (% by | (% by | (% by | Acetylacetone |
| | mass) | mass) | mass) | mass) | mass) | mass) | (% by mass) |
| Example 3 | 68.3 | 30 | 0.6 | 0.4 | 0.5 | 0.1 | 0.1 |
| Example 4 | 68.1 | 30 | 0.6 | 0.4 | 0.5 | 0.1 | 0.3 |
| Comparative | 68.4 | 30 | 0.6 | 0.4 | 0.5 | 0.1 | — |
| Example 2 | | | | | | | |

TABLE 4

| | Deposit on | Deposit on top |
|---|---|---|
| | sidewall of wiring | surface of wiring |
| Example 3 | ◯ | ◯ |
| Example 4 | ◯ | ◯ |
| Comparative | ◯ | Δ |
| Example 2 | | |

### Examples 5 to 9

A substrate having an Al wiring layer formed was subjected to dry etching in accordance with a method generally used to form a wiring pattern. The unnecessary resist film was then removed by O₂ plasma ashing, and the resultant Al wiring substrate was cleaned by a dipping method at 25° C. for 3 minutes using a stripping-cleaning solution shown in Table 5. After the cleaning, the substrate was washed with running pure water, and dried under N₂ blow, and then baked at 100° C. for 10 minutes, and the resultant substrate was examined under a scanning electron microscope (SEM).

As can be seen from Table 6, when acetylacetone (β-diketone compound) was incorporated as a bidentate ligand, the deposit on the top surface of the wiring could be completely removed. From the viewpoint of preventing corrosion of the Al layer, the amount of the acetylacetone incorporated was found to be preferably 0.1 to 20% by mass, more preferably 0.1 to 5% by mass.

In Table 6, with respect to the removal of the deposited substance, the symbols represent as follows: “O: Completely removed”; and “Δ: Partially remained”. With respect to the Al corrosion, the symbols represent as follows: “O: No corrosion was observed”; “Δ: Very slight corrosion was observed”; and “X: Marked corrosion was observed”.

### Comparative Example 3

Using a stripping-cleaning solution having substantially the same composition as that in Examples 5 to 9 except that acetylacetone (β-diketone compound) as a bidentate ligand was not incorporated as shown in Table 5, the wiring substrate was cleaned by a dipping method at 25° C. for 3 minutes. After the cleaning, the substrate was washed with running pure water, and dried under N₂ blow, and then baked at 100° C. for 10 minutes, and the resultant substrate was examined under a scanning electron microscope (SEM).

As can be seen from Table 6, the deposit on the top surface of the wiring was partially remained.

### Comparative Example 4

Using a stripping-cleaning solution having substantially the same composition as that in Examples 5 to 10 except that acetylacetone (β-diketone compound) as a bidentate ligand was incorporated in an amount not lower than the upper limit (20% by mass) as shown in Table 5, the wiring substrate was cleaned by a dipping method at 25° C. for 3 minutes. After the cleaning, the substrate was washed with running pure water, and dried under N₂ blow, and then baked at 100° C. for 10 minutes, and the resultant substrate was examined under a scanning electron microscope (SEM).

As can be seen from Table 6, when acetylacetone was added in an amount of 30% by mass, the deposit on the top surface of the wiring could be removed, but the Al layer suffered marked corrosion.

TABLE 5

| | NMP | H₂O | NH₄F | TMAF | Thioglycerol | Acetylenol | |
|---|---|---|---|---|---|---|---|
| | (% by | (% by | (% by | (% by | (% by | (% by | Acetylacetone |
| | mass) | mass) | mass) | mass) | mass) | mass) | (% by mass) |
| Example 5 | 68.3 | 30 | 0.6 | 0.4 | 0.5 | 0.1 | 0.1 |
| Example 6 | 67.4 | 30 | 0.6 | 0.4 | 0.5 | 0.1 | 1.0 |
| Example 7 | 63.4 | 30 | 0.6 | 0.4 | 0.5 | 0.1 | 5.0 |
| Example 8 | 58.4 | 30 | 0.6 | 0.4 | 0.5 | 0.1 | 10.0 |
| Example 9 | 48.4 | 30 | 0.6 | 0.4 | 0.5 | 0.1 | 20.0 |
| Comparative | 68.4 | 30 | 0.6 | 0.4 | 0.5 | 0.1 | — |
| Example 3 | | | | | | | |
| Comparative | 38.4 | 30 | 0.6 | 0.4 | 0.5 | 0.1 | 30.0 |
| Example 4 | | | | | | | |

TABLE 6

| | Deposit on top | |
|---|---|---|
| | surface of wiring | Al corrosion |
| Example 5 | ◯ | ◯ |
| Example 6 | ◯ | ◯ |
| Example 7 | ◯ | ◯ |
| Example 8 | ◯ | Δ |
| Example 9 | ◯ | Δ |
| Comparative | Δ | ◯ |
| Example 3 | | |
| Comparative | ◯ | X |
| Example 4 | | |

Stripping-Cleaning Solution (B)

### Example 10

A substrate having an Al wiring layer formed was subjected to dry etching in accordance with a method generally used to form a wiring pattern. The unnecessary resist film was then removed by O₂ plasma ashing, and the resultant Al wiring substrate was cleaned by a dipping method at 70° C. for 5 minutes using a stripping-cleaning solution prepared by adding to a 10% by mass aqueous solution of ammonium acetate (pH: 5.0) acetylacetone in an amount of 1.0% by mass, based on the mass of the aqueous solution of ammonium acetate. After the cleaning, the substrate was washed with running pure water, and dried under N₂ blow, and then baked at 100° C. for 10 minutes, and the resultant substrate was examined under a scanning electron microscope (SEM).

As can be seen from Table 7, when acetylacetone (β-diketone compound) was incorporated as a bidentate ligand in an amount of 1% by mass, the removing ability for the deposit on the sidewall of the wiring and the deposit on the top surface of the wiring was improved.

In Table 7, with respect to the removal of the deposit, the symbols represent as follows: “O: Completely removed”; and “X: Could not removed”.

### Comparative Example 5

Using a stripping-cleaning solution having substantially the same composition as that in Example 10 except that acetylacetone (β-diketone compound) as a bidentate ligand was not incorporated, the wiring substrate was cleaned by a dipping method at 75° C. for 5 minutes. After the cleaning, the substrate was washed with running pure water, and dried under N₂ blow, and then baked at 100° C. for 10 minutes, and the resultant substrate was examined under a scanning electron microscope (SEM).

As can be seen from Table 7, the deposit on the sidewall of the wiring could be completely removed, but almost all the deposit on the top surface of the wiring remained.

TABLE 7

| | Deposit on | Deposit on top |
|---|---|---|
| | sidewall of wiring | surface of wiring |
| Example 10 | ◯ | ◯ |
| Comparative | ◯ | X |
| Example 5 | | |

### Examples 11 to 14

A substrate having an Al wiring layer formed was subjected to dry etching in accordance with a method generally used to form a wiring pattern. The unnecessary resist film was then removed by O₂ plasma ashing, and the resultant Al wiring substrate was cleaned by a dipping method at 70° C. for 5 minutes using a stripping-cleaning solution prepared by adding to a 10% by mass aqueous solution of ammonium acetate (pH: 5.0) acetylacetone at a proportion shown in Table 8. After the cleaning, the substrate was washed with running pure water, and dried under N₂ blow, and then baked at 100° C. for 10 minutes, and the resultant substrate was examined under a scanning electron microscope (SEM).

As can be seen from Table 9, when acetylacetone (β-diketone compound) was incorporated as a bidentate ligand in an amount higher than 0.5%, the removing ability for the deposit on the top surface of the wiring was improved. Furthermore, no Al corrosion was observed, and the solubility of acetylacetone was excellent.

In Table 8, with respect to the solubility of acetylacetone, the symbols represent as follows: “O: Dissolved”; “Δ: Oil appeared on the surface of the solution”; and “X: Phase separation occurred”. In Table 9, with respect to the removal of the deposited substance, the symbols represent as follows: “O: Completely removed”; “Δ: Slight deposit remained”; and “X: Could not removed”. With respect to the corrosion of the Al layer, the symbols represent as follows: “O: No corrosion was observed”; “Δ: Very slight corrosion was observed”; and “X: Marked corrosion was observed”.

### Comparative Example 6

Using a stripping-cleaning solution having substantially the same composition as that in Examples 11 to 14 except that acetylacetone (β-diketone compound) as a bidentate ligand was not incorporated, the wiring substrate was cleaned by a dipping method at 70° C. for 5 minutes. After the cleaning, the substrate was washed with running pure water, and dried under N₂ blow, and then baked at 100° C. for 10 minutes, and the resultant substrate was examined under a scanning electron microscope (SEM).

As can be seen from Table 9, almost all the deposit on the top surface of the wiring remained.

### Comparative Example 7

Using a stripping-cleaning solution having substantially the same composition as that in Examples 11 to 14 except that acetylacetone (β-diketone compound) as a bidentate ligand was incorporated in an amount not higher than the lower limit (0.5% by mass), the wiring substrate was cleaned by a dipping method at 70° C. for 5 minutes. After the cleaning, the substrate was washed with running pure water, and dried under N₂ blow, and then baked at 100° C. for 10 minutes, and the resultant substrate was examined under a scanning electron microscope (SEM).

As can be seen from Table 9, almost all the deposit on the top surface of the wiring remained.

### Comparative Examples 8 to 10

A stripping-cleaning solution was prepared by incorporating acetylacetone (β-diketone compound) as a bidentate ligand in an amount not lower than the upper limit (10% by mass) as shown in Table 8. As can be seen from Table 8, acetylacetone was not dissolved, and a phenomenon was noticed such that oil appeared on the surface of the stripping-cleaning solution or phase separation occurred. From the result, it is presumed that the removing ability for the deposit on the top surface of the wiring in these Comparative Examples is poor, as compared to that in Examples.

TABLE 8

| | Acetylacetone | |
|---|---|---|
| | (% by mass) | Solubility |
| Example 11 | 0.5 | ◯ |
| Example 12 | 1.0 | ◯ |
| Example 13 | 5.0 | ◯ |
| Example 14 | 10.0 | ◯ |
| Comparative | 0 | — |
| Example 6 | | |
| Comparative | 0.1 | ◯ |
| Example 7 | | |
| Comparative | 11.0 | Δ |
| Example 8 | | |
| Comparative | 12.0 | Δ |
| Example 9 | | |
| Comparative | 15.0 | X |
| Example 10 | | |

TABLE 9

| | Deposit on top | |
|---|---|---|
| | surface of wiring | Al corrosion |
| Example 11 | Δ | ◯ |
| Example 12 | ◯ | ◯ |
| Example 13 | ◯ | ◯ |
| Example 14 | ◯ | ◯ |
| Comparative | X | ◯ |
| Example 6 | | |
| Comparative | X | ◯ |
| Example 7 | | |

As described above, the stripping-cleaning solution according to the present invention can selectively strip and remove a deposit on the top surface of a pattern wiring wherein the deposit is difficult to strip, and therefore the stripping-cleaning solution is advantageously used in a fabrication process for semiconductor having metal wiring.

The present invention has been described with reference to the preferred examples. However, it should be understood that the invention can easily incorporate various amendments and modifications by persons skilled in the art, without departing from the scope of the invention. Accordingly, the above disclosure should be construed as merely illustrative and not as limitative. The present invention is only limited by the appended claims and by equivalent scope of the claims.

1. A stripping-cleaning solution capable of selectively stripping and removing a deposit generated on the top surface of a metal wiring of a semiconductor substrate, the stripping-cleaning solution comprising:
at least a fluorine compound, a water-soluble organic solvent, water, and a bidentate ligand in an amount of 0.1 to 20% by mass based on the total mass of the stripping-cleaning solution.

2. The stripping-cleaning solution according to claim 1, wherein the atoms in the bidentate ligand, which are capable of simultaneously coordinating to a metal, are oxygen atoms.

3. The stripping-cleaning solution according to claim 1, wherein the bidentate ligand is a compound represented by the following formula (1): 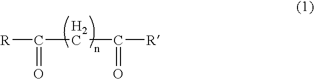
wherein n represents an integer of 0 to 3, and each of R and R′ represents an alkyl group, an aryl group, or a derivative thereof.

4. The stripping-cleaning solution according to claim 1, further comprising a corrosion inhibitor.

5. The stripping-cleaning solution according to claim 1, further comprising a surfactant.

6. A method for cleaning a semiconductor substrate, comprising a step of:
bringing the stripping-cleaning solution according to claim 1 into contact with a semiconductor substrate in a process for forming a metal wiring to remove a deposit generated at least on the top surface of the metal wiring.

7. A method for forming a metal wiring, comprising the steps of:
forming a metal wiring layer on a substrate;
forming a photoresist layer on the metal wiring layer obtained at the step of forming a metal wiring layer, and subjecting the photoresist layer to exposure and development treatment to form a predetermined photoresist pattern;
subjecting the metal wiring layer to dry etching using the photoresist pattern as a mask obtained at the step of forming a photoresist pattern to form a predetermined metal wiring pattern;
removing the unnecessary resist layer by O₂ plasma ashing after forming the metal wiring pattern; and
removing a deposit generated at least on the top surface of the metal wiring after the step of removing the resist by using the stripping-cleaning solution according to claim 1.

8. A stripping-cleaning solution capable of selectively stripping and removing a deposit generated on the top surface of a metal wiring of a semiconductor substrate, the stripping-cleaning solution comprising:
at least a basic aqueous solution, at least one selected from an organic compound having a carboxyl group and an anhydride thereof, water, and a bidentate ligand in an amount of 0.5 to 10% by mass based on the total mass of the stripping-cleaning solution.

9. The stripping-cleaning solution according to claim 8, wherein the atoms in the bidentate ligand, which are capable of simultaneously coordinating to a metal, are oxygen atoms.

10. The stripping-cleaning solution according to claim 8, wherein the bidentate ligand is a compound represented by the following formula (1): 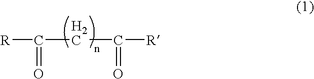
wherein n represents an integer of 0 to 3, and each of R and R′ represents an alkyl group, an aryl group, or a derivative thereof.

11. The stripping-cleaning solution according to claim 8, wherein the basic aqueous solution is aqueous ammonia.

12. The stripping-cleaning solution according to claim 8, further comprising a corrosion inhibitor.

13. The stripping-cleaning solution according to claim 8, further comprising a surfactant.

14. A method for cleaning a semiconductor substrate, comprising a step of:
bringing the stripping-cleaning solution according to claim 8 into contact with a semiconductor substrate in a process for forming a metal wiring to remove a deposit generated at least on the top surface of the metal wiring.

15. A method for forming a metal wiring, comprising the steps of:
forming a metal wiring layer on a substrate;
forming a photoresist layer on the metal wiring layer obtained at the step of forming a metal wiring layer, and subjecting the photoresist layer to exposure and development treatment to form a predetermined photoresist pattern;
subjecting the metal wiring layer to dry etching using the photoresist pattern as a mask obtained at the step of forming a photoresist pattern to form a predetermined metal wiring pattern;
removing the unnecessary resist layer by O₂ plasma ashing after forming the metal wiring pattern; and
removing a deposit generated at least on the top surface of the metal wiring after the step of removing the resist by using the stripping-cleaning solution according to claim 8.
